(19) United States
(12) Patent Application Publication
(10) Pub. No.: US 2024/0039040 A1
(43) Pub. Date: Feb. 1, 2024

(54) SOLID ELECTROLYTE SHEET AND SOLID-STATE BATTERY

(71) Applicant: TOYOTA JIDOSHA KABUSHIKI KAISHA, Toyota-shi (JP)

(72) Inventor: Ippei GOTO, Okazaki-shi (JP)

(73) Assignee: TOYOTA JIDOSHA KABUSHIKI KAISHA, Toyota-shi (JP)

(21) Appl. No.: 18/224,377

(22) Filed: Jul. 20, 2023

(30) Foreign Application Priority Data
Jul. 29, 2022 (JP) 2022-121957

(51) Int. Cl. H01M 10/0562; H01M 10/0525; H01M 50/446; H01M 50/44

(52) U.S. Cl. CPC H01M 10/0562; H01M 10/0525; H01M 50/446; H01M 50/44; H01M 2300/0088; H01M 2300/0068

(57) ABSTRACT

A solid electrolyte sheet of the present disclosure comprises a nonwoven fabric and a solid electrolyte disposed inside the nonwoven fabric. The pore diameter of the nonwoven fabric is 15 μm or less. The ratio of the pore diameter relative to a particle diameter of the solid electrolyte (pore diameter/particle diameter) is 5.0 or more.

### CROSS-REFERENCE TO RELATED APPLICATIONS

This application claims priority under 35 USC 119 from Japanese Patent Application No. 2022-121957 filed on Jul. 29, 2022, the disclosure of which is incorporated by reference herein in its entirety.

### BACKGROUND

### Technical Field

The present disclosure relates to a solid electrolyte sheet and a solid-state battery.

### Related Art

Conventionally, as a lithium-ion secondary battery having excellent safety characteristics, a solid-state battery provided with a solid electrolyte layer is known.

JP-A No. 2016-31789 discloses a solid electrolyte sheet used in a solid electrolyte layer. The solid electrolyte sheet disclosed in JP-A No. 2016-31789 contains a nonwoven fabric and a solid electrolyte. The solid electrolyte is arranged at the surface of, and inside, the nonwoven fabric. The mass per square meter of the nonwoven fabric is 8 g or less. The thickness of the nonwoven fabric is from 10 μm to 25 μm.

### SUMMARY

In general, a nonwoven fabric has plural three-dimensional spaces (hereinafter, also referred to as “pores”) in the interior thereof, and the distribution of the size of the pores (hereinafter, also referred to as “pore diameter”) is broad. JP-A No. 2016-31789 does not provide any disclosure regarding the pore diameter of a nonwoven fabric.

In the solid electrolyte sheet disclosed in JP-A No. 2016-31789, there is a concern that a solid electrolyte cannot be retained at a location at which the pore diameter of the nonwoven fabric is large. As a result, the battery resistance of a solid-state battery may increase.

Furthermore, in the manufacturing process of a solid-state battery, there is a concern that metal foreign matter may be mixed into the material of the solid-state battery. The metal foreign matter is usually a metal piece having a size of 20 μm. When metal foreign matter is mixed into the solid electrolyte sheet disclosed in JP-A No. 2016-31789, there is a concern that the metal foreign matter might penetrate the solid electrolyte layer at the time of battery pressing. “Battery pressing” refers to pressing in which a positive electrode layer, a solid electrolyte layer, and a negative electrode are layered and integrated in this order. As a result, a short circuit may occur in a solid-state battery.

The present disclosure has been made in view of the foregoing circumstances.

The problem to be solved by an embodiment of the present disclosure is to provide a solid electrolyte sheet that can suppress the battery resistance of a solid-state battery and, further, prevent the occurrence of a short circuit even if metal foreign matter is mixed into the interior of the solid-state battery.

The problem to be solved by another embodiment of the present disclosure is to provide a solid-state battery in which a short circuit is unlikely to occur even if metal foreign matter is mixed into the interior of the solid-state battery, while also suppressing the battery resistance of the solid-state battery.

The means for solving the foregoing problems include the following embodiments.

<1> A solid electrolyte sheet, including:
a nonwoven fabric; and
a solid electrolyte disposed at an interior of the nonwoven fabric, in which:
a pore diameter of the nonwoven fabric is 15 μm or less, and
a ratio of the pore diameter relative to a particle diameter of the solid electrolyte (pore diameter/particle diameter) is 5.0 or more.

<2> The solid electrolyte sheet according to <1> above in which a thickness of the nonwoven fabric is from 10 μm to 30 μm.

<3> The solid electrolyte sheet according to <1> above, in which the particle diameter is 3.0 μm or less.

<4> The solid electrolyte sheet according to any one of <1> above, in which the solid electrolyte comprises a sulfide solid electrolyte.

<5> A solid-state battery, including a positive electrode layer, a negative electrode layer, and a solid electrolyte layer disposed between the positive electrode layer and the negative electrode layer,
in which the solid electrolyte layer includes the solid electrolyte sheet according to any one of <1> above.

According to an embodiment of the present disclosure, a solid electrolyte sheet is provided that can prevent the occurrence of a short circuit even if metal foreign matter is mixed into a solid-state battery, while also suppressing the battery resistance of a solid-state battery.

According to another embodiment of the present disclosure, a solid-state battery is provided in which the battery resistance of the solid-state battery is suppressed, and short circuiting is unlikely to occur even if metal foreign matter is mixed into the interior of the solid-state battery.

### DETAILED DESCRIPTION

In the present disclosure, numerical ranges indicated using “-” mean a range in which the numerical values described before and after the “-” are included as the minimum value and the maximum value, respectively.

In numerical ranges described stepwise in the present disclosure, the upper limit value or the lower limit value described in a given numerical range may be replaced with the upper limit value or the lower limit value of the numerical range of another stepwise description. In the numerical ranges described in this disclosure, the upper limit value or the lower limit value described in a given numerical range may be replaced with a value shown in the examples.

In the present disclosure, a combination of two or more preferable embodiments is a more preferable embodiment.

In the present disclosure, the amount of each component means, unless otherwise specified, the total amount of plural types of substances in a case in which there are plural types of substances corresponding to each component.

In the present disclosure, the term “step” includes not only as an independent step, but also a step that cannot be clearly distinguished from another step as long as the intended purpose of the step is achieved.

(1) Solid Electrolyte Sheet

A solid electrolyte sheet of the present disclosure includes a nonwoven fabric and a solid electrolyte disposed inside the nonwoven fabric. The pore diameter of the nonwoven fabric is 15 μm or less. A ratio (pore diameter/particle diameter) is 5.0 or more. The ratio (pore diameter/particle diameter) indicates the pore diameter with respect to the particle diameter of the solid electrolyte.

A “nonwoven fabric” is a sheet-shaped fabric which is adhered or entangled without weaving fibers, and indicates a planar fiber aggregate in which a predetermined level of structural strength has been obtained by physical and/or chemical methods other than weaving, knitting or papermaking (JIS L0222:2022). The fiber aggregate has plural pores.

The “pore diameter” represents the maximum pore diameter according to the bubble point method (JIS K3832).

Since the solid electrolyte sheet of the present disclosure has the above-described configuration, while suppressing the battery resistance of a solid-state battery, occurrence of short circuiting can be prevented even if metal foreign matter is mixed into the interior of the solid-state battery.

This effect is presumed to be exhibited for the following reasons, although there is no limitation thereto.

In the manufacturing process of solid-state batteries, there is a possibility that metal foreign matter may enter the interior of a solid-state battery. The metal foreign matter is usually a metal piece having a size of 20 μm. In the present disclosure, the pore diameter of the nonwoven fabric is 15 μm or less, and is smaller than the particle diameter of the metal foreign matter. Therefore, even if metal foreign matter is mixed into the material of the solid-state battery of the present disclosure, the metal foreign matter is unlikely to penetrate into the interior of the nonwoven fabric. As a result, during battery pressing, the metal foreign matter is unlikely to penetrate the solid electrolyte layer. As a result, it is presumed that the solid electrolyte sheet of the present disclosure can prevent the occurrence of short circuiting even if metal foreign matter enters the interior of the solid-state battery.

Furthermore, in the present disclosure, the ratio (pore diameter/particle diameter) is 5.0 or more. Therefore, the solid electrolyte can be disposed inside the nonwoven fabric more densely than in a case in which the ratio (pore diameter/particle diameter) is not 5.0 or more. As a result, in the solid-state battery of the present disclosure, gaps between plural adjacent particles of the solid electrolyte become smaller. It is presumed that the solid electrolyte sheet of the present disclosure can suppress the battery resistance of a solid-state battery as a result of this.

The shape of the solid electrolyte sheet in plan view is not particularly limited, and examples thereof include a rectangular shape. Examples of the rectangle include a square and a rectangle.

The thickness of the solid electrolyte sheet depends on the thickness of the nonwoven fabric, and may be equal to or greater than the thickness of the nonwoven fabric. From the viewpoint of further reducing the battery resistance of solid-state batteries, for example, the thickness of the solid electrolyte sheet is preferably 50 μm or less, more preferably 30 μm or less, yet more preferably 20 μm or less, and particularly preferably 15 μm or less. The thickness of the solid electrolyte sheet is preferably 1 μm or more, and more preferably 10 μm or more. The thickness of the solid electrolyte sheet is preferably 1 μm to 50 μm.

(1.1) Nonwoven Fabric

The solid electrolyte sheet includes a nonwoven fabric.

The pore diameter of the nonwoven fabric is 15 μm or less, and from the viewpoint of further reducing the battery resistance of solid-state batteries, is preferably 13 μm or less, and more preferably 8 μm or less. From the viewpoint of further reducing the battery resistance of solid-state batteries, for example, the pore diameter of the nonwoven fabric is preferably 1 μm or more, and more preferably 3 μm or more. The pore diameter of the nonwoven fabric is preferably 1 μm to 15 μm.

The method for measuring the pore diameter of the nonwoven fabric is the same as the method described in the examples.

The mass per unit area of the nonwoven fabric is not particularly limited, and from the viewpoint of further reducing the battery resistance of solid-state batteries, is preferably 0.10 mg/cm² or more, more preferably 0.20 mg/cm² or more, and yet more preferably 0.30 mg/cm² or more. The mass per unit area of the nonwoven fabric is not particularly limited, and from the viewpoint of further reducing the battery resistance of solid-state batteries, is preferably 0.80 mg/cm² or less, more preferably 0.60 mg/cm² or less, and yet more preferably 0.40 mg/cm² or less. The mass per unit area of the nonwoven fabric is preferably 0.10 mg/cm² to 0.80 mg/cm².

The method for measuring the mass per unit area of a nonwoven fabric is the same as the method described in the examples.

The porosity of the nonwoven fabric is not particularly limited, and from the viewpoint of further reducing the battery resistance of solid-state batteries, is preferably 50% or more, more preferably 60% or more, and yet more preferably 70% or more. From the viewpoint of enabling the nonwoven fabric to function as a support, the porosity of the nonwoven fabric is preferably 95% or less, and more preferably 90% or less. The porosity of the nonwoven fabric is preferably 50% to 95%.

Porosity refers to the volume of voids within the nonwoven fabric relative to the total volume of the nonwoven fabric.

The method for measuring the porosity of the nonwoven fabric is the same as the method described in the examples.

The thickness of the nonwoven fabric is not particularly limited, and is preferably 10 μm to 30 μm. When the thickness of the nonwoven fabric is 10 μm to 30 μm, the thickness of the solid electrolyte layer of the solid-state battery can be further reduced. As a result, the battery resistance of a solid-state battery can be further reduced.

The thickness of the nonwoven fabric is more preferably 11 μm or more, yet more preferably 12 μm or more, and particularly preferably 13 μm or more. From the viewpoint of further reducing the battery resistance of solid-state batteries, for example, the thickness of the nonwoven fabric is more preferably 25 μm or less, yet more preferably 20 μm or less, and particularly preferably 18 μm or less.

The method for measuring the thickness of the nonwoven fabric is the same as the method described in the examples.

The type of the nonwoven fabric is not particularly limited, and examples thereof include meltblown nonwoven fabrics, spunbonded nonwoven fabric, carded nonwoven fabric, parallel laid nonwoven fabric, cross-laid nonwoven fabric, random laid nonwoven fabric, spunlaid nonwoven fabric, flashspun nonwoven fabric, chemical bonded nonwoven fabric, hydroentangled nonwoven fabric, needle-punched nonwoven fabric, stitch-bonded nonwoven fabric, thermobonded nonwoven fabric, burst fiber nonwoven fabric, tow opening nonwoven fabric, and film-split nonwoven fabric.

Among these, the type of nonwoven fabric is preferably a meltblown nonwoven fabric. Meltblown nonwoven fabrics are formed from ultrafine fibers (e.g., fibers having a diameter of 1 μm to 6 μm). Therefore, in meltblown nonwoven fabrics, even if the mass per unit area is low, the number of fibers contained in the nonwoven fabric is large. As a result, a nonwoven fabric in which each of the pore diameter, the mass per unit area and the porosity is within the above-described ranges is easily obtained.

The fiber diameter and the fiber length of the fiber are not particularly limited. The fiber may be filament and may be stable fiber. The cross-sectional shape of the fiber is not particularly limited, and examples thereof include a circular shape, an oval shape, and an irregular shape.

Examples of the material of the fiber include resins and glass. Examples of the resins include polyester-based resins, polyolefin-based resins, and polyamide-based resins.

Examples of the polyester-based resins include polyethylene terephthalate (PET). Examples of the polyolefin-based resins include polyethylene (PE) and polypropylene (PP). Examples of the polyamide-based resins include nylon and aramid.

(1.2) Solid Electrolyte

The solid electrolyte sheet includes a solid electrolyte.

The solid electrolyte may or may not cover the nonwoven fabric as long as it is disposed inside the nonwoven fabric.

Examples of the shape of the solid electrolyte include particulate form. The particle diameter of the solid electrolyte is preferably 3.0 μm or less. When the particle diameter of the solid electrolyte is 3.0 μm or less, the battery resistance of a solid-state battery can be reduced as compared to a case in which the particle diameter of the solid electrolyte is more than 3.0 μm. The particle diameter of the solid electrolyte is preferably 0.05 μm or more, more preferably 0.2 μm or more, more preferably 1.0 μm or more, and particularly preferably 2.0 μm or more. The particle diameter of the solid electrolyte is more preferably 2.8 μm or less, more preferably 2.6 μm or less, and particularly preferably 2.4 μm or less. The particle diameter of the solid electrolyte is preferably 0.05 μm to 3.0 μm.

The particle diameter of the solid electrolyte is preferably smaller than the thickness of the nonwoven fabric. Relative to the total volume of voids in the nonwoven fabric, the proportion of the total volume of the solid electrolyte may be 50% by volume or more, may be 70% by volume or more, and may be 90% by volume.

The method for measuring the particle diameter of the solid electrolyte is the same as the method described in the examples.

The ratio (pore diameter/particle diameter) is 5.0 or more, and from the viewpoint of filling efficiency of a solid electrolyte, is preferably 5.5 or more, and more preferably 6.0 or more. From the viewpoint of resistance to foreign matter, the ratio (pore diameter/particle diameter) is preferably 55.0 or less, more preferably 40.0 or less, yet more preferably 20.0 or less, particularly preferably 10.0 or less, and still more preferably 6.0 or less. The ratio (pore diameter/particle diameter) is preferably 5.0 to 55.0.

Among these, it is preferable that the thickness of the nonwoven fabric is 20 μm or less and the ratio (pore diameter/particle diameter) is 5.0 to 6.0. When the thickness of the nonwoven fabric is 20 μm or less and the ratio (pore diameter/particle diameter) is 5.0 to 6.0, the battery resistance of a solid-state battery can be further reduced.

Examples of the solid electrolyte include sulfide solid electrolytes, oxide solid electrolytes, hydride solid electrolytes, halide solid electrolytes, and nitride solid electrolytes. As the solid electrolyte, only one type may be used singly, or two or more types may be used in combination. The sulfide solid electrolytes preferably contain sulfur (S) as the main component of the anionic element. The oxide solid electrolytes preferably contain oxygen (O) as the main component of the anionic element. The hydride solid electrolytes preferably contain hydrogen (H) as the main component of the anionic element. The halide solid electrolytes preferably contain a halogen element (X) as the main component of the anion element. The nitride solid electrolytes preferably contain nitrogen (N) as the main component of the anionic element.

(1.2.1) Sulfide Solid Electrolyte

The sulfide solid electrolytes preferably contain, for example, an Li element, an element A, and an S element. The element A is at least one of P, As, Sb, Si, Ge, Sn, B, Al, Ga or In. The sulfide solid electrolyte may further contain at least one of an O element or a halogen element. Examples of the halogen element (X) include an F element, a Cl element, a Br element, and an I element.

From the viewpoint of excellent chemical stability, it is preferable to have an anionic structure of an ortho composition as a main component of the anionic structure. Examples of the anionic structure of the ortho composition include a PS₄³⁻ structure, an SiS₄⁴⁻ structure, a GeS₄⁴⁻ structure, an AlS₃³⁻ structure, or a BS₃³⁻ structure. The proportion of the anionic structure of the ortho composition is preferably 70 mol % or more, and more preferably 90 mol % or more, relative to the total anionic structure in the sulfide solid electrolyte.

The sulfide solid electrolyte may be amorphous or may be crystalline. When the sulfide solid electrolyte is crystalline, the sulfide solid electrolyte has a crystalline phase. Examples of the crystalline phase include a Thio-LISICON crystalline phase, an LGPS-type crystalline phase, and an argyrodite-type crystalline phase.

The composition of the sulfide solid electrolyte is not particularly limited, and examples thereof include xLi₂S-(100-x)P₂S₅ (70≤x≤80), and yLiI-zLiBr-(100-y-z)(xLi₂S-(1-x)P₂S₅) (0.7≤x≤0.8, 0≤y≤30, 0≤z≤30).

The sulfide solid electrolyte may have a composition represented by general formula (1): Li₄₋ₓGe₁₋ₓPₓS₄ (0<x<1). In general formula (1), at least a part of Ge may be substituted with at least one of Sb, Si, Sn, B, Al, Ga, In, Ti, Zr, V or Nb. In general formula (1), at least a part of P may be substituted with at least one of Sb, Si, Sn, B, Al, Ga, In, Ti, Zr, V or Nb. In general formula (1), part of Li may be substituted with at least one of Na, K, Mg, Ca or Zn, In general formula (1), a part of S may be substituted with halogen. The halogen is at least one of F, Cl, Br, or I.

Examples of other compositions of the sulfide solid electrolyte include Li₇₋ₓ₋₂Z PS_{6-x-y} X_{y}, Li_{8-x-2y} SIS_{6-x-y} X_{y}, and Li_{8-z-2y}GeS_{6-x-y} X_{y}. In these compositions, X is at least one of F, Cl, Br, or I, and x and y are 0≤x, 0≤y.

(1.2.2) Oxide Solid Electrolyte

The oxide solid-electrolyte contains, for example, an Li element, an element Z (Z is at least one of Nb, B, Al, Si, P, Ti, Zr, Mo, W or S), and an O element. Examples of the oxide solid electrolyte include garnet-type solid electrolytes, perovskite-type solid electrolytes, NASICON-type solid electrolytes, Li—P—O based solid electrolytes, and Li—B—O based solid electrolytes. Examples of the garnet-type solid electrolytes include Li₇La₃Zr₂O₁₂, Li₇₋ₓLa₃(Zr₂₋ₓNbₓ)O₁₂ (0≤x≤12), and Li₅La₃Nb₂O₁₂. Examples of the perovskite-type solid electrolytes include (Li, La)TiO₃, (Li, La)NbO₃, and (Li, Sr)(Ta, Zr)O₃. Examples of the NASICON-type solid electrolytes include Li(Al, Ti)(PO₄)₃, and Li(Al, Ga)(PO₄)₃. Examples of the Li—P—O-based solid electrolytes include Li₃PO₄, and LIPON (compounds in which part of the O of the Li3PO4 is substituted with N), and examples of the Li—B—O-based solid electrolytes include Li₃BO₃, and a compound in which a part of the O of the Li₃BO₃ is substituted with C.

(1.2.3) Hydride Solid Electrolyte

The hydride solid electrolytes have, for example, Li and a complex anion containing hydrogen. Examples of the complex anion include (BH₄)⁻, (NH₂)⁻, (AlH₄)⁻, and (AlH₆)³⁻.

(1.2.4) Halide Solid Electrolyte

Examples of the halide solid electrolytes include Li₆3z Z_{z}X₆ (X being at least one of Cl or Br, and z being 0<z<2).

(1.2.5) Nitride Solid Electrolyte

Examples of the nitride solid electrolytes include Li₃N.

(1.2.6) Molten Salt Solid at 25° C.

Other examples of solid electrolytes include molten salts that are solid at 25° C. Molten salts have cations and anions. Examples of the cations include inorganic cations and organic cations.

Examples of the inorganic cations include lithium ions.

Examples of the organic cations include ammonium-based ions, piperidinium cations, pyrrolidinium-based cations, imidazolium-based cations, viridium-based cations, alicyclic amine-based cations, aliphatic amine diameter cations, and aliphatic phosphonium-based cations.

Examples of the anions include anions having a sulfonylamide structure. Examples of anions having a sulfonium amide structure include bis(trifluoromethanesulfonyl)amide, bis(fluorosulfonyl)amide, bis(pentafluoroethanesulfonyl)amide, and (fluorosulfonyl)(trifluoromethanesulfonyl)amide. The melting point of the molten salt is usually 25° C. or more, may be 30° C. or more, and may be 40° C. or more. The melting point of the molten salt is, for example, 200° C. or less, may be 150° C. or less, and may be 120° C. or less.

(1.2.7) Flexible Crystalline Solid Electrolyte

Other examples of solid electrolytes include flexible crystalline solid electrolytes. Flexible crystals are composed of regularly aligned three-dimensional crystal lattices. In flexible crystals, orientational and rotational disorder exists at the molecular species or molecular ion level. Flexible crystals have cations and anions. Examples of the cations include pyrrolidinium, tetraalkylammonium, and tetraalkylphosphonium. Examples of the anions include hexafluorophosphate, tetrafluoroborate, thiocyanate, bis(trifluoromethanesulfonyl)amide, and (fluorosulfonyl)(trifluoromethanesulfonyl)amide.

Among these, the solid electrolyte preferably contains a sulfide solid electrolyte, and more preferably consists of a sulfide solid electrolyte. When the solid electrolyte contains a sulfide solid electrolyte, the battery resistance of a solid-state battery is further reduced.

(1.3) Binder

The solid electrolyte sheet may or may not comprise a binder.

Examples of the binder include rubber-based binders and fluoride-based binders. Examples of the rubber-based binder include butadiene rubber, hydrogenated butadiene rubber, styrene butadiene rubber (SBR), hydrogenated styrene butadiene rubber, nitrile butadiene rubber, hydrogenated nitrile butadiene rubber, and ethylene propylene rubber. Examples of the fluoride-based binder include polyvinylidene fluoride (PVDF), polyvinylidene fluoride-polyhexafluoropropylene copolymer (PVDF-HFP), polytetrafluoroethylene, and fluororubber.

When the solid electrolyte contains a binder, the content of the binder may be 0 parts by mass to 3 parts by mass with respect to the total amount of the solid electrolyte.

(2) Solid-State Battery

A solid-state battery of the present disclosure includes a positive electrode layer, a negative electrode layer, and a solid electrolyte layer disposed between the positive electrode layer and the negative electrode layer. The solid electrolyte layer includes the solid electrolyte sheet of the present disclosure.

Since the solid-state battery of the present disclosure has the above-described configuration, while the battery resistance of the solid-state battery is suppressed, short circuiting is unlikely to occur even if metal foreign matter is mixed into the interior of the solid-state battery.

This effect is presumed to be for the same reason as for the effect of the solid electrolyte sheet described above; however, there is no limitation thereto.

When the set of the positive electrode layer, the solid electrolyte layer, and the negative electrode layer is used as a power generation unit, a solid-state battery may have only one power generation unit, or may have two or more power generation units. When a solid-state battery has two or more power generation units, the power generation units may be connected in series or may be connected in parallel.

(2.1) Solid Electrolyte Layer

A solid-state battery includes a solid electrolyte layer. The solid electrolyte layer comprises a solid electrolyte sheet of the present disclosure and may consist only of the solid electrolyte sheet of the present disclosure. The solid electrolyte layer is subjected to battery pressing.

From the viewpoint of further reducing the battery resistance of a solid-state battery, for example, the thickness of the solid electrolyte layer is preferably 50 μm or less, preferably 30 μm or less, yet more preferably 20 μm or less, and yet more preferably 15 μm or less. The thickness of the solid electrolyte layer is preferably 1 μm or more, and more preferably 10 μm or more. The thickness of the solid electrolyte layer is preferably 1 μm to 50 μm.

Solid electrolyte layers have a history of being subjected to battery pressing. Owing to the battery pressing, both the nonwoven fabric and the solid electrolyte contained in the solid electrolyte sheet are unlikely to be deformed. As a result, each of the nonwoven fabric and the solid electrolyte contained in the solid electrolyte sheet after the battery pressing, and each of the nonwoven fabric and the solid electrolyte contained in the solid electrolyte sheet before the battery pressing is applied can be regarded as the same.

The pore diameter of the nonwoven fabric contained in the solid electrolyte layer is obtained, for example, by separating only the nonwoven fabric from the solid-state battery by washing with an organic solvent, and measuring the pore diameter of the obtained nonwoven fabric in the same manner as described in the examples.

The particle diameter of the solid electrolyte contained in the solid electrolyte layer is obtained, for example, by observing the cross-section of the solid electrolyte layer with a scanning electron microscope (SEM), randomly selecting particles of the solid electrolyte, and measuring an average value of the particle diameter.

The nonwoven fabric contained in the solid electrolyte and at least one of the positive electrode layer or the negative electrode layer may or may not be in direct contact with each other. Another solid electrolyte layer may be disposed between the nonwoven fabric contained in the nonwoven fabric of the solid electrolyte and at least one of the positive electrode layer or the negative electrode layer. By disposing another solid electrolyte layer, the internal resistance of the solid-state battery is reduced. The other solid electrolyte layer contains a solid electrolyte, and may contain a binder if necessary. Examples of the solid electrolyte and the binder include the same substances as those exemplified as the solid electrolyte and the binder that can be contained in the solid electrolyte sheet. The other solid electrolyte layer typically does not have electronic conductivity. The other solid electrolyte layer does not contain a nonwoven fabric. The thickness of the other solid electrolyte layer is not particularly limited.

(2.2) Positive Electrode Layer

The solid-state battery comprises a positive electrode layer. The positive electrode layer contains a positive electrode active material. The positive electrode layer may further contain at least one of a solid electrolyte, a conductive material, or a binder, as necessary. Examples of the positive electrode active material include oxide active materials. Examples of the oxide active materials include rock-salt layered active materials, spinel-type active materials, and olivine-type active materials. Examples of the rock salt layered active materials include LiCoO₂, LiMnO₂, LiNiO₂, LiVO₂ and LiNi_{1/3}Co_{1/3}Mn_{1/3}O₂. Examples of the spinel-type active materials include LiMn₂O₄, Li₄Ti₅O₁₂ and Li(Ni_{0.5}Mn_{1.5})O₄. Examples of the olivine-type active materials include LiFePO₄, LiMnPO₄, LiNiPO₄ and LiCoPO₄.

A protective layer may be formed at the surface of the oxide active material. The protective layer contains an Li-ion conductive oxide. The protective layer can suppress reaction between the oxide active material and the solid electrolyte. Examples of the Li-ion conductive oxide include LiNbO₃. The thickness of the protective layer is, for example, 1 nm to 30 nm. As the positive electrode active material, for example, Li₂S can be used.

Examples of the shape of the positive electrode active material include particulate form. The particle diameter of the positive electrode active material is not particularly limited, and is preferably 10 nm or more, and more preferably 100 nm or more. The particle diameter of the positive electrode active material is not particularly limited, and is preferably 50 μm or less, and more preferably 20 μm or less. The particle diameter of the positive electrode active material is preferably 10 nm to 50 μm.

The method for measuring the particle diameter of the positive electrode active material is the same as the method described in the examples.

The positive electrode layer may contain a conductive material. Examples of the conductive material include carbon materials, metal particles, and conductive polymers. Examples of the carbon materials include particulate carbon materials and fibrous carbon materials. Examples of the particulate carbon materials include acetylene black (AB) and Ketjen black (KB). Examples of the fibrous carbon materials include carbon nanotubes (CNTs) and carbon nanofibers (CNFs).

Examples of the solid electrolyte and the binder used for the positive electrode layer include the same substances as those exemplified as the solid electrolyte and the binder which can be contained in the solid electrolyte sheet. The thickness of the positive electrode layer is not particularly limited, and is preferably 0.1 μm to 1000 μm.

(2.3) Positive Electrode Current Collector

The solid-state battery may further include a positive electrode current collector. The positive electrode current collector collects current in the positive electrode layer. The positive electrode current collector is disposed at a position at an opposite side from the solid electrolyte layer with respect to the positive electrode layer.

Examples of the material of the positive electrode current collector include stainless steel, aluminum, nickel, iron, titanium, and carbon. Examples of the shape of the positive electrode current collector include a foil shape and a mesh shape.

(2.4) Negative Electrode Layer

The solid-state battery includes a negative electrode layer. The negative electrode layer contains a negative electrode active material. The negative electrode layer may contain at least one of a solid electrolyte, a conductive material, or a binder, as necessary. Examples of the negative electrode active material include Li-based active materials, carbon-based active materials, oxide-based active materials, and Si-based active materials. Examples of the Li-based active materials include metallic lithium and lithium alloys. Examples of the carbon-based active materials include graphite, hard carbon, and soft carbon. Examples of the oxide-based active materials include lithium titanate. Examples of the Si-based active materials include simple Si, Si alloys, and silicon oxide.

Examples of the shape of the negative electrode active material include particulate form. The particle diameter of the negative electrode active material is preferably 10 nm or more, and more preferably 100 nm or more. The particle diameter of the negative electrode active material is preferably 50 μm or less, and more preferably 20 μm or less. The particle diameter of the negative electrode active material is preferably 10 nm to 50 μm.

The method for measuring the particle diameter of the negative electrode active material is the same as the method described in the examples.

Examples of the conductive material, the solid electrolyte and the binder used for the negative electrode layer include the same substances as those exemplified as the conductive material, the solid electrolyte and the binder that can be contained in the positive electrode layer. The thickness of the negative electrode layer is not particularly limited, and is preferably 0.1 μm to 1000 μm.

(2.5) Negative Electrode Current Collector

The solid-state battery may further include a negative electrode current collector. The negative electrode current collector collects current in the negative electrode layer. The negative electrode current collector is disposed at a position at an opposite side from the solid electrolyte layer with respect to the negative electrode layer. Examples of the material of the negative electrode current collector include stainless steel, copper, nickel, and carbon. Examples of the shape of the negative electrode current collector include a foil shape and a mesh shape.

(2.6) Exterior Body

The solid-state battery may further include an exterior body. The exterior body houses at least the above-described power generation unit. Examples of the exterior body include a laminate-type exterior body and a case-type exterior body.

(2.7) Restraining Member

The solid-state battery may further include a restraining member. The restraining member applies restraining pressure to the positive electrode layer, the solid electrolyte layer, and the negative electrode layer in the thickness direction. The restraining pressure is preferably 0.1 MPa or more, more preferably 1 MPa or more, and even more preferably 5 MPa or more. The restraining pressure is preferably 100 MPa or less, more preferably 50 MPa or less, and still more preferably 20 MPa or less. The restraining pressure is preferably 0.1 MPa to 100 MPa.

(2.8) Use Application

The solid-state battery of the present disclosure is typically a solid-state lithium-ion secondary battery. Examples of the solid-state battery include power source for a vehicle, an electronic device, electrical storage and the like. Examples of the vehicle include electric four-wheeled vehicles, electric two-wheeled vehicles, gasoline vehicles, and diesel vehicles. Examples of the electric four-wheeled vehicles include an electric vehicle (BEV), a plug-in hybrid vehicle (PHEV), and a hybrid vehicle (BEV). Examples of the electric two-wheeled vehicles include an electric motorcycle and an electrically-assisted bicycle. Examples of the electronic devices include hand-held devices (for example, smartphones, tablet computers, and audio players), portable devices (for example, laptop computers, and CD (Compact Disc) players), and movable equipment (for example, power tools, and professional video cameras). Among these, applications of the solid-state battery of the present disclosure are preferably as a power supply for driving a hybrid vehicle, a plug-in hybrid vehicle or an electric vehicle.

### EXAMPLES

Hereinafter, the present disclosure will be described in more detail with reference to examples. The invention of the present disclosure is not limited to these examples only.

### [1] Measurement Method

The method for measuring the physical properties of the materials of the examples and comparative examples is as follows.

### [1.1] Pore Diameter of Nonwoven Fabric

The pore diameter of the nonwoven fabric was measured by the bubble point method (JIS K 3832). Specifically, air pressure was applied to paper completely immersed in a test solution, and the maximum pore diameter was calculated from the pressure (bubble point) at which bubbles were observed to have appeared. By using a test liquid with known surface tension, the maximum pore diameter, d, can be calculated using the following equation. d=γ/P (γ: surface tension of test liquid, P: bubble point pressure)

### [1.2] Mass Per Unit Area of Nonwoven Fabric

A sheet having a predetermined area was cut from the nonwoven fabric. The mass per unit area was determined by calculating the mass per area of the sheet.

### [1.3] Porosity of Nonwoven Fabric

The volume of the voids was calculated from the difference between the actual volume of the sheet and the volume calculated from the specific gravity of the material, and the ratio of the voids to the actual volume of the sheet was determined. The ratio of voids was defined as the porosity.

### [1.4] Thickness

The thickness of the nonwoven fabric was measured with a tabletop micrometer.

The thickness of the solid electrolyte layer was confirmed by radiation X-ray laminography or cross-sectional SEM.

### [1.5] Particle Diameter

The particle diameters of the sulfide solid electrolyte, the positive electrode active material, the negative electrode active material, and the metal foreign matter were measured using a laser diffraction particle size distribution analyzer. Specifically, the object to be measured was dispersed in a dispersion medium, the volume-based particle diameter distribution was measured using a particle size distribution measurement apparatus, and the particle diameter corresponding to a value of the obtained volume-basis cumulative particle diameter distribution of 50% was defined as the particle diameter.

### [1.6] Specific Surface Area

The specific surface areas of the positive electrode active material, the negative electrode active material, the conductive material for the positive electrode, and the conductive material for the negative electrode were measured by the BET method (JIS R 1626-1996).

### [2] Solid Electrolyte Sheet

### [2.1] Example 1

The following materials were prepared.

First sulfide solid electrolyte: 15LiBr-10LiI-75(0.75Li₂S-0.25P₂S₅) glass ceramic having a particle size of 2.2 μm

Binder: SBR (styrene-butadiene rubber)-based binder

Dispersion medium: butyl butyrate

Substrate foil: stainless steel (SUS) foil having a thickness of 15 μm

A first nonwoven fabric was prepared by melt-blowing. The first nonwoven fabric has a thickness of 30 μm, a mass per unit area of 0.37 mg/cm², a porosity of 91%, and a pore diameter of 15 μm. The material of the fibers configuring the first nonwoven fabric was polyethylene terephthalate.

100 parts by mass of the first sulfide solid electrolyte and 3 parts by mass of the binder were blended into the dispersion medium so as to obtain a solid content of 50% by mass. By subjecting the resulting mixture to ultrasonic dispersion treatment using an ultrasonic dispersion apparatus for 1 minute, a solid electrolyte paste was obtained.

The first nonwoven fabric was disposed on the substrate foil. The electrolyte paste was uniformly applied onto the first nonwoven fabric by blade coating so as to obtain a mass per unit area of 2.9 mg/cm², and the mixture was dried at 100° C. for 60 minutes. A commercially available applicator was used for blade coating. As a result, a solid electrolyte sheet with a substrate foil was obtained. A solid electrolyte sheet with a substrate foil has a substrate foil, and a solid electrolyte sheet arranged on one surface of the substrate foil. The solid electrolyte sheet has a first nonwoven fabric and a solid electrolyte. The solid electrolyte was disposed inside and outside the first nonwoven fabric so as to cover the first nonwoven fabric.

### [2.2] Example 2

Other than using a second nonwoven fabric instead of the first nonwoven fabric, a solid electrolyte sheet with a substrate foil was obtained in the same manner as in Example 1. The second nonwoven fabric has a thickness of 15 μm, a mass per unit area of 0.37 mg/cm², a porosity of 82%, and a pore diameter of 11 μm. The material of the fibers configuring the second nonwoven fabric was polyethylene terephthalate.

### [2.3] Example 3

Other than using a third nonwoven fabric in place of the first nonwoven fabric and using a second sulfide solid electrolyte in place of the first sulfide solid electrolyte, a solid electrolyte sheet with a substrate foil was obtained in the same manner as in Example 1. The third nonwoven fabric has a thickness of 15 μm, a mass per unit area of 0.67 mg/cm², a porosity of 68%, and a pore diameter of 5 μm. The material of the fibers configuring the third nonwoven fabric was polyethylene terephthalate. The second sulfide solid electrolyte is a 15LiBr-10LiI-75(0.75Li₂S-0.25P₂S₅) glass ceramic having a particle size of 0.1 μm.

### [2.4] Comparative Example 1

Apart from the fact that the first nonwoven fabric was not used, a solid electrolyte sheet with a substrate foil was obtained in the same manner as in Example 1. The solid electrolyte sheet with a substrate foil of Comparative Example 1 does not include a nonwoven fabric.

### [2.5] Comparative Example 2

Apart from the fact that a fourth nonwoven fabric was used instead of the first nonwoven fabric, a solid electrolyte sheet with a substrate foil was obtained in the same manner as in Example 1. The fourth nonwoven fabric was prepared by a spun-bonding method. The fourth nonwoven fabric has a thickness of 20 μm, a mass per unit area of 0.89 mg/m², a porosity of 68%, and a pore diameter of 73 μm. The material of the fibers configuring the fourth nonwoven fabric was polyethylene terephthalate.

### [2.6] Comparative Example 3

A solid electrolyte sheet with a substrate foil was obtained in the same manner as in Example 1 except that the third nonwoven fabric was used instead of the first nonwoven fabric.

### [3] Evaluation

Using the respective solid electrolyte sheets of Examples 1 to 3 and Comparative Examples 1 to 3, plural solid-state batteries for evaluation containing metal foreign matter were prepared. Foreign matter evaluation and resistance measurement were performed for each of the plural solid-state batteries for evaluation. The details are as follows.

### [3.1] Solid-State Battery for Evaluation

[3.1.1] Positive Electrode

The following materials were prepared.

Positive electrode active material: LiNi_{1/3}Mn_{1/3}Co_{1/3}O₂ powder having a particle size of 10 μm and a specific surface area of 1 m²/g

Solid electrolyte for positive electrode: first sulfide solid electrolyte having the same composition as the sulfide solid electrolyte of the solid electrolyte sheet

Conductive material for positive electrode: cellulose nanofibers (CNFs) having a specific surface area of 14 m²/g

Binder for positive electrode: SBR (styrene-butadiene rubber)-based binder

Dispersion medium for positive electrode: butyl butyrate

Positive electrode current collector: aluminum foil having a thickness of 15 μm

LiNbO₃ was coated on the surface of the positive electrode active material using the sol-gel method to obtain a positive electrode active material with a protective layer.

100 parts by mass of the positive electrode active material with a protective layer, 50 parts by mass of the sulfide solid electrolyte for a positive electrode, 10 parts by mass of the positive electrode conductive material, and 1 part by mass of the positive electrode binder were blended into a dispersion medium for a positive electrode so as to obtain a solid content of 60% by mass. By subjecting the resulting mixture to ultrasonic dispersion treatment using an ultrasonic dispersion apparatus for 1 minute, a positive electrode paste was obtained.

The positive electrode paste was uniformly coated on the positive electrode current collector by blade coating so as to obtain a mass per unit area of 25 mg/cm², and the mixture was dried at 100° C. for 60 minutes. A commercially available applicator was used for blade coating. As a result, a positive electrode layer with a positive electrode current collector was obtained. A positive electrode layer with a positive electrode current collector has a positive electrode current collector, and a positive electrode layer disposed on one surface of the positive electrode current collector. The positive electrode layer contains a positive electrode active material with a protective layer, a sulfide solid electrolyte for a positive electrode, a conductive material for a positive electrode, and a binder for a positive electrode.

[3.1.2] Negative Electrode

The following materials were prepared.

Negative electrode active material: Si powder having a particle size of 3 μm and a specific surface area of 4 m²/g

Solid electrolyte for negative electrode: first sulfide solid electrolyte having the same composition as the sulfide solid electrolyte of the solid electrolyte sheet

Conductive material for negative electrode: CNF having a specific surface area of 14 m²/g

Binder for negative electrode: SBR-based binder

Dispersion medium for negative electrode: butyl butyrate

Negative electrode current collector: surface-roughened copper foil having a thickness of 20 μm

100 parts by mass of the negative electrode active material, 100 parts by mass of the sulfide solid electrolyte for a negative electrode, 10 parts by mass of the conductive material for negative electrode, and 2 parts by mass of a dispersant for a negative electrode were blended into a dispersion medium for a negative electrode so as to obtain a solid content of 40% by mass. By subjecting the resulting mixture to ultrasonic dispersion treatment using an ultrasonic dispersion apparatus for 1 minute, a negative electrode paste was obtained.

The negative electrode paste was uniformly coated on the negative electrode current collector by blade coating so as to obtain a mass per unit area of 5 mg/cm², and the mixture was dried at 100° C. for 60 minutes. A commercially available applicator was used for blade coating. As a result, a negative electrode layer with a negative electrode current collector was obtained. A negative electrode layer with a negative electrode current collector has a negative electrode current collector, and a negative electrode layer disposed on one surface of the negative electrode current collector. The negative electrode layer contains a negative electrode active material, a sulfide solid electrolyte for a negative electrode, a conductive material for a negative electrode, and a binder for a negative electrode.

[3.1.3] Laminate

The following materials were prepared.

Solid electrolyte sheet with substrate foil: solid electrolyte sheets of Examples 1 to 3 and Comparative Examples 1 to 3

Metal foreign matter: SUS fine powder having a particle size of 20 μm

Exterior Body: laminate film made of aluminum to which positive and negative electrode terminals are attached

A negative electrode layer with a negative electrode current collector was cut into a square shape of 1.2 cm×1.2 cm, and a negative electrode structure was obtained. A solid electrolyte sheet with a substrate foil was cut into a square shape of 1.2 cm×1.2 cm, and a solid electrolyte structure was obtained. A positive electrode layer with a positive electrode current collector was cut into a square shape of 1.0 cm×1.0 cm, and a positive electrode structure was obtained.

A metal foreign substance was placed on the negative electrode layer of the negative electrode structure. Then, the negative electrode structure and the solid electrolyte structure were layered such that the negative electrode layer and the solid electrolyte sheet oppose each other, and were roll-pressed at a pressing pressure of 1 ton/cm.

Then, the substrate foil attached to the solid electrolyte layer was peeled off, and the positive electrode structure and the solid electrolyte structure were layered such that the positive electrode layer and the solid electrolyte sheet oppose each other, and were roll-pressed at a pressing pressure of 4 ton/cm. As a result, a laminate electrode body was obtained.

The laminate electrode body was sealed with an exterior body to prepare a solid-state battery for evaluation (solid-state lithium-ion secondary battery). The thickness of the solid electrolyte layer of the solid-state battery for evaluation of Example 1 was 15 μm. The thickness of the solid electrolyte layer of the solid-state battery for evaluation of Example 2 and Example 3 was 15 μm.

### [3.2] Foreign Matter Evaluation

A voltage was measured in a state in which the solid-state battery for evaluation is restrained by a load of 5 MPa in the lamination direction of the positive electrode layer, the solid electrolyte layer, and the negative electrode layer, and in accordance with the following criteria, it was evaluated whether or not a short circuit occurred in the solid-state battery for evaluation. The evaluation results are shown in Table 1.

Evaluation criterion [A] indicates that it has been determined that a short circuit has not occurred. Evaluation criterion [B] indicates that it has been determined that a short circuit has occurred.

<Evaluation Criteria>

A: The voltage is greater than 0.200 V

B: The voltage is 0.200 V or less

### [3.3] Resistance Measurement

A solid-state battery for evaluation, which has a foreign matter evaluation of [A], was subjected to constant current-constant voltage (CC-CV) charging and CC-CV discharging at a current value of 2 mA, an upper limit voltage of 4.5 V, and a lower limit voltage of 2.5 V. Then, CC-CV charging was performed at a current value of 2 mA and an upper limit voltage of 3.6 V, and CC-CV charging was stopped. After 10 minutes had elapsed from the time at which CC-CV charging was stopped, constant current (CC) discharge was performed for 10 seconds at a current value of 10 mA and a lower limit voltage of 0.0 V. The battery resistance R (=ΔV/I) of the solid-state battery for evaluation was calculated according to Ohm's law. ΔV represents the difference between the voltage immediately before energization of the CC discharge and the voltage at a discharge time of 10 seconds. I represents a measured value of the current value of the CC discharge. Table 1 shows the calculation results of the battery resistance of the solid-state battery for evaluation.

The allowable range of the battery resistance of the solid-state battery for evaluation is 110% or less as a ratio of the battery resistance of Example 1.

TABLE 1

| | Solid electrolyte sheet | | | | | | Evaluation (20 μm) | | |
|---|---|---|---|---|---|---|---|---|---|
| | | | | | | Ratio | | | Resistance |
| | Nonwoven fabric | | | | SE | (pore | Foreign matter | | measurement |
| | | mass per | | Pore | Particle | diameter/ | evaluation | | Battery |
| | Thickness | unit area | Porosity | diameter | diameter | particle | Voltage | Evaluation | resistance |
| | μm | mg/cm² | % | μm | μm | diameter) | V | result | % |
| Example 1 | 30 | 0.37 | 91 | 15 | 2.2 | 6.8 | 0.248 | A | 100 |
| Example 2 | 15 | 0.37 | 82 | 11 | 2.2 | 5.0 | 0.205 | A | 98 |
| Example 3 | 15 | 0.67 | 68 | 5 | 0.1 | 50.0 | 0.270 | A | 103 |
| Comparative | — | — | — | — | 2.2 | — | 0.000 | B | — |
| Example 1 | | | | | | | | | |
| Comparative | 20 | 0.89 | 68 | 73 | 2.2 | 33.2 | 0.000 | B | — |
| Example 2 | | | | | | | | | |
| Comparative | 15 | 0.67 | 68 | 5 | 2.2 | 2.3 | 0.241 | A | 1547 |
| Example 3 | | | | | | | | | |

In Table 1, “SE” represents a solid electrolyte. “Evaluation (20 μm)” indicates evaluation of a solid-state battery for evaluation into which metal foreign matter having a particle size of 20 μm was mixed.

The solid electrolyte sheet of Comparative Example 1 does not comprise a nonwoven fabric. Therefore, the foreign matter evaluation of Comparative Example 1 was [B]. In other words, a short circuit occurred in the solid-state battery for evaluation of Comparative Example 1.

In the solid electrolyte sheet of Comparative Example 2, the pore diameter of the nonwoven fabric was not 15 μm or less, and was greater than the particle diameter of the metal foreign matter. Therefore, the foreign matter evaluation of Comparative Example 2 was [B]. In other words, a short circuit occurred in the solid-state battery for evaluation of Comparative Example 2.

In the solid electrolyte sheet of Comparative Example 3, the ratio (pore diameter/particle diameter) was not 5.0 or more. Therefore, the battery resistance of Comparative Example 3 was 1547%, which is remarkably high.

The solid electrolyte sheet of Examples 1 to 3 included a nonwoven fabric and a solid electrolyte disposed inside the nonwoven fabric, the nonwoven fabric had a pore diameter of 15 μm or less, and the ratio (pore diameter/particle diameter) was 5.0 or more. Therefore, the foreign matter evaluation of Examples 1 to 3 was [A]. In other words, no short circuit occurred in the solid-state batteries for evaluation of Examples 1 to 3. Furthermore, the battery resistances of Examples 1 to 3 were 103% or less.

From these results, it can be understood that the solid electrolyte sheets of Examples 1 to 3 can prevent the occurrence of short circuiting even if metal foreign matter is mixed into the interior of a solid-state battery, while also suppressing the battery resistance of the solid-state battery.

From the comparison between Examples 1 to 3 and Comparative Example 3, when the pore diameter of the nonwoven fabric is 15 μm or less, during battery pressing, metal foreign matter having a particle diameter greater than the pore diameter is unlikely to enter into the interior of the nonwoven fabric. In other words, it is difficult for the metal foreign matter to penetrate the solid electrolyte layer. As a result, it is inferred that short circuiting is unlikely to occur in the solid-state batteries for evaluation of Examples 1 to 3.

From the comparison between Examples 1 to 3 and Comparative Example 2, by having a ratio (pore diameter/particle diameter) of 5.0 or more, the solid electrolyte is disposed inside the nonwoven fabric more densely than in a case in which the ratio (pore diameter/particle diameter) is not 5.0 or more. In other words, after the battery pressing, the gaps between particles of plural adjacent solid electrolytes become smaller. As a result, it is inferred that the battery resistances of the solid-state batteries for evaluation of Examples 1 to 3 were 103% or less.

What is claimed is:

1. A solid electrolyte sheet, comprising:
a nonwoven fabric; and
a solid electrolyte disposed at an interior of the nonwoven fabric, wherein:
a pore diameter of the nonwoven fabric is 15 μm or less, and
a ratio of the pore diameter relative to a particle diameter of the solid electrolyte (pore diameter/particle diameter) is 5.0 or more.

2. The solid electrolyte sheet according to claim 1, wherein a thickness of the nonwoven fabric is from 10 μm to 30 μm.

3. The solid electrolyte sheet according to claim 1, wherein the particle diameter is 3.0 μm or less.

4. The solid electrolyte sheet according to claim 1, wherein the solid electrolyte includes a sulfide solid electrolyte.

5. A solid-state battery, comprising:
a positive electrode layer;
a negative electrode layer; and
a solid electrolyte laver disposed between the positive electrode layer and the negative electrode layer,
wherein the solid electrolyte layer includes the solid electrolyte sheet according to claim 1.
